(19) United States
(12) Patent Application Publication
(10) Pub. No.: US 2011/0203333 A1
(43) Pub. Date: Aug. 25, 2011

(54) Menace garage lock - MGL

(76) Inventor: Robert Jimenez, Chula Vista, CA (US)

(21) Appl. No.: 12/932,135

(22) Filed: Feb. 16, 2011

Related U.S. Application Data
(60) Provisional application No. 61/338,215, filed on Feb. 16, 2010.

(51) Int. Cl. E05B 65/08

(52) U.S. Cl. 70/95

(57) ABSTRACT

The Menace Garage Lock-MGL is mounted to each side of the door, and the abutting door frame is equipped with the dead bolt receiver or housing, a one-quarter inch cast steel plate bolted to the frame, with a U-shaped bracket into which the dead bolt slides. The dead bolt is cylindrical and possesses the unique characteristic of rotating freely upon its longitudinal axis, which means that even if a thief attempted to saw through it with a hacksaw blade, the dead bolt simply rotates, and thus cannot be cut.

### CLAIM OF PRIORITY

This patent application claims priority under 35 USC 119 (e) (1) from U.S. Provisional Patent Application Ser. No. 61/338,215 filed Feb. 16, 2010, of common inventorship herewith entitled, “Menace Garage Lock-MGL.”

### FIELD OF THE INVENTION

The present invention pertains to the field of garage door locks, and more specifically to the field of garage door deadbolts.

### BACKGROUND OF THE INVENTION

The prior art has put forth several designs for garage door deadbolts. Among these are:

U.S. Pat. No. 4,480,863 to Michael Hormann describes a latch assembly for use in combination with slidable doors is disclosed. A rotatable disk is connected to the door so that the plane of the disk is perpendicular to the door and parallel to the direction of door movement. A lock bolt which projects from the door jam is adapted to engage a slot in the disk as the door closes, causing the disk to rotate. As the disk rotates, it slides with respect to a spring loaded latch bolt until the bolt slides through a second slot in the disk, when the door is fully closed.

U.S. Pat. No. 4,739,584 to Peter Zellman describes an auxiliary or backup locking mechanism which is used primarily with garage doors of the swing-up type which are controlled by an automatic garage door opener. The backup mechanism causes the lower corners of the door to be secured when in the closed position and to be unlocked by the operation of the garage door opener when the door is to be opened.

U.S. Pat. No. 6,382,005 to Bryan A. White and Clyde D. Herman describes a remote controllable dead bolt type of locking apparatus is to be retrofittedly mounted in conjunction with a conventional garage door which is to function to securely lock the garage door preventing unauthorized entry though the garage door. The locking apparatus uses an elongated draw bar assembly that connects between the right side door jamb and the left side door jamb which defines the transverse sides of the opening within which is mounted the garage door.

None of these prior art references describe the present invention.

### SUMMARY OF THE INVENTION

It is an object of the present invention to provide a garage door dead bolt locking device.

### BRIEF DESCRIPTION OF THE DRAWINGS

FIG. 1 is an elevational angled perspective view of the device of the present invention installed on a garage door.

FIG. 2 is a close-up elevational angled perspective view of the device of the present invention for sliding garage doors and universal applications.

FIG. 3 is a close-up elevational angled perspective view of another embodiment of the device of the present invention for pull up garage doors.

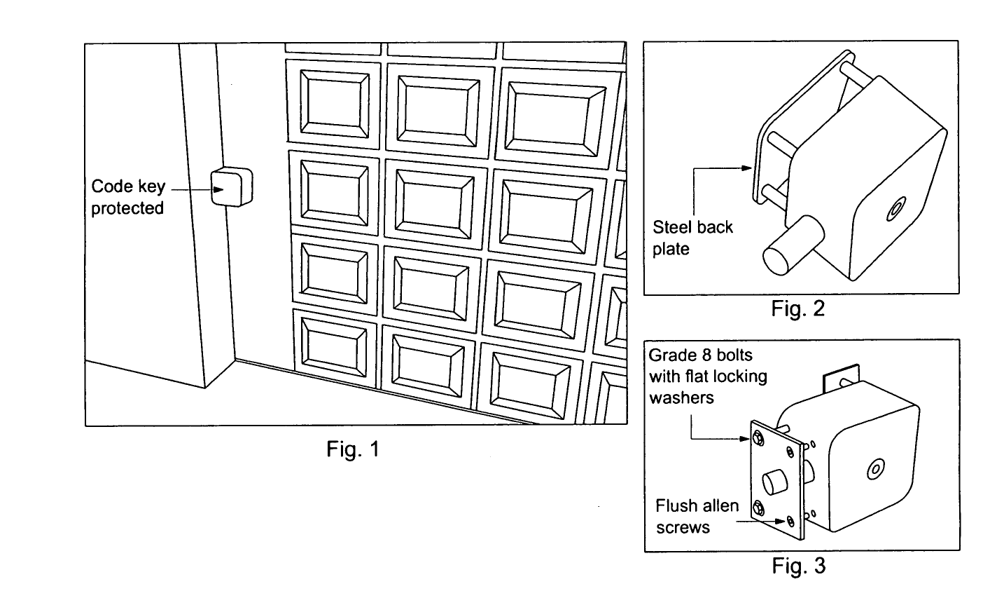

### DETAILED DESCRIPTION OF THE INVENTION

Locks are the means we use to protect our material possessions. We lock our cars, our houses, our garages. Even the best lock, we know, can be defeated or circumvented by a canny burglar, who can always break a window, but a frail or inadequate lock is virtually an invitation to the thief. For the most part, our homes and cars are secured with dependable locks. The locks on garage doors, however, which should protect our cars, a long list of tools and other possessions and in fact our houses, are generally weak and easily foiled. This is a major shortcoming because once the thief is inside your garage he's out of sight and well on his way into your house.

The present invention, hereinafter referred as the Menace Garage Lock-MGL is a heavy-duty, single cylinder key-and-dead bolt lock, designed to be permanently mounted on garage doors, storage-shed doors, and other pull-up or sliding doors. The Menace Garage Lock-MGL is manufactured of casehardened steel, and measures approximately three inches in height and width, one and one-half inches in depth. The Menace Garage Lock-MGL is operated by a standard, coded key or in another embodiment, by a flush cylindrical key similar to those found on drink machines. The Menace Garage Lock-MGL distinguishes itself from ordinary garage locks chiefly in respect to its heavier construction, and the design features of its mounting hardware. Most sliding or pull-up garage doors, if equipped with a factory-installed lock, generally possess a keyed lock that binds or releases a rotating handle or lever. When turned, this handle thrusts or retracts a narrow metal rod which fits into a receiving bracket on either side of the door. Thus, the lock itself locks only the handle, not the door. Breaking in is a simple matter of forcing the lock so that the handle moves freely. A simple matter, because these locks are relatively lightweight in construction. Where garage doors have not been furnished with a factory lock, homeowners generally employ a strap-and-hasp with a padlock. Again, this is a poor defense against any thief with a hacksaw or crowbar. The Menace Garage Lock-MGL approaches the problem differently. This lock functions to thrust and retract a one-half inch casehardened or in another embodiment, stainless steel dead bolt, two inches in length. The lock mechanism is manufactured in brass, pick and drill-resistant, and set within the steel casing. The Menace Garage Lock-MGL is mounted to each side of the door, and the abutting door frame is equipped with the dead bolt receiver or housing, a one-quarter inch cast steel plate bolted to the frame, with a U-shaped bracket into which the dead bolt slides. The dead bolt is cylindrical and possesses the unique characteristic of rotating freely upon its longitudinal axis, which means that even if a thief attempted to saw through it with a hacksaw blade, the dead bolt simply rotates, and thus cannot be cut. The Menace Garage Lock-MGL is mounted permanently to the garage door. The mounting hardware is the second distinguishing feature of this invention. The Menace Garage Lock-MGL is not simply placed into a drilled hole and fastened by screws. Instead, this lock is mounted on a steel backing plate, one-quarter inch in thickness, which fits into a recess on the back side of the lock's casing, and can be removed for maintenance of the lock mechanism. A second one-quarter inch backing plate is fitted to the interior surface of the garage door, and through-bolted to the lock's casing by four bolts, seven-sixteenth inch in diameter and two inches in length. Thus, the Menace Garage Lock-MGL is mounted permanently to the garage door, impervious to hacksaws, crowbars, and other tools of forced entry. To get past the Menace Garage Lock-MGL, a thief would need to take an axe to the door, or remove the door entirely.

There are several embodiments with different configurations of mounting-plates, reflecting the variety of door-and-jamb constructions that are fitted with the Menace Garage Lock-MGL.

A single cylinder keyed dead bolt lock designed for garage doors, shed doors, and similar applications, the Menace Garage Lock-MGL presents a number of distinct and significant benefits and advantages. Foremost, the Menace Garage Lock-MGL employs casehardened steel, a brass lock mechanism, a unique free-spinning dead bolt, and a steel-plate mounting system to compose a lock of uncommon strength, solidity, and resistance. The brass lock mechanism ensures easy one-hand operation of the lock, as the user simply inserts the key and turns clockwise to thrust the dead bolt, counterclockwise to retract it. The Menace Garage Lock-MGL is mounted on two steel plates, solidly bolted into place to “sandwich” the door, and anchoring the lock to securely resist tampering or prying. Further, the lock mechanism is highly resistant to picking, and the casehardened steel of the outer casing resists drilling. If a thief attempted to saw through the steel dead bolt, the bolt simply rotates beneath the saw blade, denying it purchase. Manufactured of high-quality components and designed for many years of faithful service, the Menace Garage Lock-MGL far exceeds conventional garage-door locks in its solidity, durability, and general strength. The Menace Garage Lock-MGL is highly versatile as well, easily installed on either the right or left side of a garage door, and equally suitable for protecting storage sheds and other outdoor buildings. As noted previously, once a thief enters your garage he has an essentially free pass into your house. With the Menace Garage Lock-MGL, the garage is protected, and the thief is denied entry.

The Menace Garage Lock-MGL provides a garage and other outbuildings with the protection of a virtually indestructible, high-precision steel lock. Easily mounted on sliding or pull-up garage doors, as well as shed doors, stable and barn doors, etc., the Menace Garage Lock-MGL outperforms both factory-installed door-locks and strap-and-hasp/padlock systems. Tough, durable, and surprisingly affordable, the Menace Garage Lock-MGL finds a wide and enthusiastic market among consumers.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A garage door dead bolt locking device, comprising: two steel plates, each approximately one quarter inch thick solidly bolted into place to “sandwich” the door, onto which the lock is mounted and anchors the lock to securely resist tampering or prying and the abutting door frame is equipped with the dead bolt receiver or housing, comprising a one-quarter inch thick cast steel plate bolted to the frame, having a U-shaped bracket into which the dead bolt slides, wherein the dead bolt is cylindrical and is capable of rotation freely upon its longitudinal axis, so that the dead bolt rotates if an attempt is made to saw through it with a hacksaw blade, and thus cannot be cut.

2. The dead bolt locking device of claim 1 wherein the lock is mounted on a steel backing plate, wherein the plate is one-quarter inch in thickness, and the plate fits into a recess on the back side of the lock's casing, and can be removed for maintenance of the lock mechanism, further comprising a second one-quarter inch backing plate fitted to the interior surface of the garage door, and through-bolted to the lock's casing by four bolts, wherein the bolts are seven-sixteenth inch in diameter and two inches in length.

3. The device of claim 1 wherein the lock is a single cylinder keyed dead bolt lock designed for garage doors, shed doors, and similar applications.

4. The device of claim 1 wherein the plates comprise casehardened steel, the lock mechanism comprises brass, and the dead bolt is free to rotate about its longitudinal axis.

5. The device of claim 1 wherein the dead bolt comprises stainless steel and is approximately two inches in length and one half inch in diameter.

6. The device of claim 1 wherein the dead bolt comprises casehardened steel and is approximately two inches in length and one half inch in diameter.
